(19) United States
(12) Patent Application Publication
(10) Pub. No.: US 2007/0030247 A1
(43) Pub. Date: Feb. 8, 2007

(54) Projection display system and cursor control method thereof

(75) Inventors: Chien-Wu Yen, Miao-Li (TW); Tzu-Hai Chung, Miao-Li (TW)

Correspondence Address: BACON & THOMAS, PLLC, 625 SLATERS LANE, FOURTH FLOOR, ALEXANDRIA, VA, 22314, US

(73) Assignee: CORETRONIC CORPORATION, Hsinchu (TW)

(21) Appl. No.: 11/492,782

(22) Filed: Jul. 26, 2006

(30) Foreign Application Priority Data
Aug. 2, 2005 (TW) 94126281

(51) Int. Cl. G09G 5/08

(52) U.S. Cl. 345/158

(57) ABSTRACT

A projection display system and cursor control method thereof is disclosed. The projection display system includes a projection display device and an operation unit. The projection display device is for displaying an image and a cursor. The projection display device includes an on screen display (OSD) unit for generating the cursor in the image. The operation unit is for controlling a moving direction of the cursor through the OSD unit.

This application claims the benefit of Taiwan application Serial No. 94126281, filed Aug. 2, 2005, the subject matter of which is incorporated herein by reference.

### BACKGROUND OF THE INVENTION

1. Field of the Invention

The invention relates in general to a projection display system, and more particularly to a projection display system and a cursor control method thereof.

2. Description of the Related Art

Referring to FIG. 1, a conventional projection display system 10 includes a projection display device 110 and a laser pen 120. The projection display device 110 is for displaying an image I1, and the laser pen 120 is for generating a red light beam L to form a cursor P1 of a red spot in the image I1. A user adjusts a position of the cursor P1through laser pen 120.

For example, the user needs the laser pen 120 to generate the cursor P1 to point at relative content in the image I1 during a presentation.

However, the laser pen costs very much, and this will increase a producing cost of the conventional projection display system and thus reduce the competitive advantage of the projection display system. Furthermore, when the user forgets to take the laser pen with himself/herself or the laser pen loses a power source, the cursor cannot be generated in the image to point at the relevant content, which leads to inconvenience and annoyance for the user.

### SUMMARY OF THE INVENTION

It is therefore an object of the present invention to provide a projection display system and a cursor control method thereof. The cursor is generated directly from the projection display device to provide for a convenient operation of a user.

The present invention achieves the above-identified object by providing a projection display system. The projection display system includes a projection display device and an operation unit. The projection display device is for displaying an image and a cursor. The projection display device includes an on screen display (OSD) unit for generating the cursor in the image. The operation unit is for controlling moving direction of the cursor through the OSD unit.

The present invention achieves the above-identified object by providing a cursor control method applied to a projection display system. The projection display system includes a projection display device and an operation unit. The projection display device is for display an image. The cursor control method includes generating a cursor in the image by using the projection display device; and controlling a position of the cursor through the operation unit and the projection display device.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of a conventional projection display system.

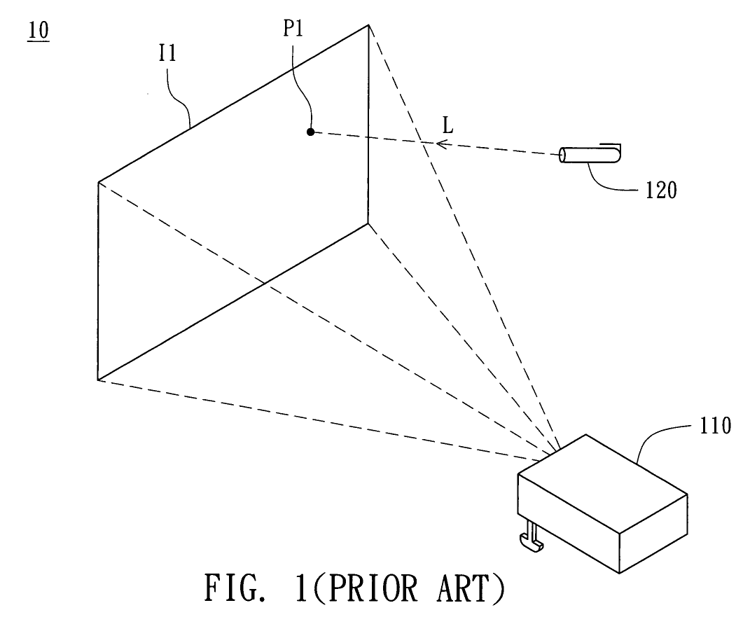

FIG. 2A is a block diagram of a projection display system according to a preferred embodiment of the present invention.

FIG. 2B is a schematic diagram of a projection display system according to a preferred embodiment of the present invention.

### DETAILED DESCRIPTION OF THE INVENTION

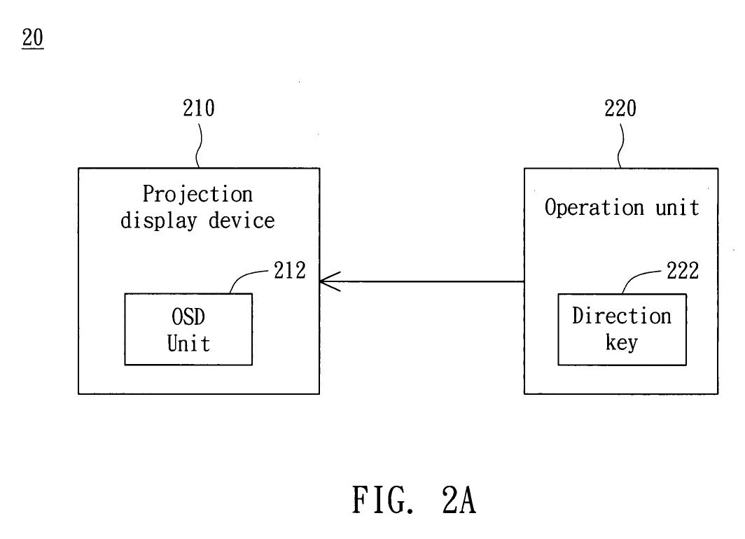

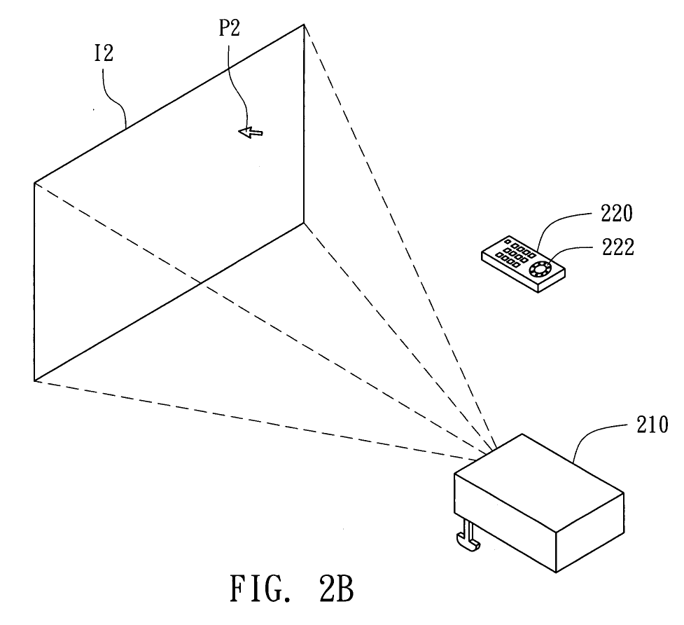

Referring to FIGS. 2A and 2B, a projection display system 20 of the present invention includes a projection display device 210 and an operation unit 220. The projection display device 210, such as a rear-projection device or a projector, is used for generating an image I2. The projection display device 210 further includes an on screen display (OSD) unit 212 for generating a cursor P2 in the image I2. The cursor P2 is adjustable to be any pattern, such as a finger, a star and an arrow, etc. In the embodiment of the present invention, the projection display device 210 is not limited to any specific type of the projection display devices.

The operation unit 220, for example a remote control, is used for controlling all functional operations of the projection display device 210, such as power switching, and brightness and contrast adjustment. In addition, the operation unit 220 further includes a direction key 222 for a user to control a moving direction of the cursor P2 in the image and enlarge or reduce the size of the cursor P2. In the embodiment, the direction key 222 is not limited to a specific form, as long as the moving direction of the cursor P2 can be adjusted in accordance with the operation of the user.

Moreover, the OSD unit 212 synchronizes the cursor P2 and image signals of the image I2 in order to generate the cursor P2 in the image 12. The projection display device 210 controls the OSD unit 212 via a digital control interface, such as IIC BUS. The OSD unit 212 includes a plurality of control registers for performing a variety of functions. The operation unit 220 fills specific numbers into the control registers to control the position, patter, color and size of the cursor P2 through the OSD unit 212 and the projection display device 210.

Referring to FIG. 2B, a schematic diagram of a projection display system of the present invention is shown. When the projection display device 210 displays the image I2, such as a power-point display image, the user controls the moving direction of the cursor P2 via the direction key 222 of the operation unit 220. For example, the direction key 222 is a cross button. When the user desires to move the cursor P2 left or right, the user continuously triggers the ‘left’ or ‘right’ button of the direction keys 222 of the operation unit 220 to fill a sequence of increasing or decreasing numbers in turn into the control register to control the left-movement and the right-movement of the cursor P2 in the image I2. Comparing to the conventional projection display system, that the cursor in the image is generated by a laser pen, the projection display device 210 of the present invention generates the cursor P2 by itself. As a result, the user needs no laser pen during a presentation. That is, the present invention can prevent the inconvenience and annoyance in the conventional projection display system that the cursor cannot be generated when the user forgets to carry the laser pen or the laser pen has on power.

Besides, owing that the cursor P2 is directly generated from the projection display device 210, the projection display system 20 of the present invention reduces the cost as compared to the conventional projection display system with a laser pen in the remote control, and thus increase the competitive advantage of the present invention in the marketplace.

According to the projection display system and the cursor control method thereof disclosed by the embodiment of the present invention, a cursor is generated in the image from the OSD unit and the moving direction of the cursor is controlled through the digital control interface of the OSD unit and the operation unit, the cursor achieves the function of the laser pen. Therefore, when compared to the conventional projection display system, the projection display system of the present invention has the following advantages:

Firstly, without need to use the laser pen, the user-required cursor can be generated in the image through the OSD unit. Therefore, the cost for the projection display system can be reduced.

Secondly, the OSD unit generates a variety of cursor patterns, and the user can select the desired cursor pattern, color and size via the operation unit. Therefore, the selection variety of the cursor can be improved.

Thirdly, the cursor is directly generated by the projection display device in the projection display system, and thus the user has a presentation without need to carry a laser pen. Thereof, the user can avoid the inconvenience and annoyance that the cursor cannot be generated when forgetting to carry the laser pen or carrying a no-power laser pen.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A projection display system, comprising:
a projection display device, for displaying an image and a cursor, the projection display device comprising an on screen display (OSD) unit for generating the cursor in the image; and
an operation unit, for controlling a moving direction of the cursor in the image through the OSD unit of the projection display device.

2. The projection display system according to claim 1, wherein the operation unit is a remote control.

3. The projection display system according to claim 2, wherein the remote control comprises a direction key for controlling the moving direction of the cursor in the image.

4. The projection display system according to claim 1, wherein the operation unit is for controlling size, shape, or color of the cursor through the OSD unit.

5. A cursor control method, applied to a projection display system comprising a projection display device and an operation unit, the projection display device for displaying an image, the cursor control method comprising:
generating a cursor in the image by using the projection display device; and
controlling a position of the cursor in the image through the operation unit and the projection display device.

6. The cursor control method according to claim 5, wherein the projection display system comprises an on screen display (OSD) unit and the cursor is generated by the OSD unit.

7. The cursor control method according to claim 6, wherein the operation unit is for controlling size, shape, or color of the cursor through the OSD unit.

8. The cursor control method according to claim 5, wherein the operation unit is a remote control.
